(19) United States
(12) Patent Application Publication
(10) Pub. No.: US 2025/0051023 A1
(43) Pub. Date: Feb. 13, 2025

(54) ALIGNMENT SYSTEMS AND METHODS

(71) Applicant: The Boeing Company, Arlington, VA (US)

(72) Inventor: Brandon Parker Jamison, Mount Pleasant, SC (US)

(73) Assignee: The Boeing Company, Arlington, VA (US)

(21) Appl. No.: 18/448,409

(22) Filed: Aug. 11, 2023

(51) Int. Cl. B64D 29/06

(52) U.S. Cl. CPC B64D 29/06; E05B 15/0006

(57) ABSTRACT

A system and a method include one or more first spring assemblies and one or more second spring assemblies. Each first spring assembly includes a first spring housing including a first pocket, a first spring disposed within the first pocket, and a first pin disposed within the first pocket and extending from the first pocket. The first pins engage a surface of a body of a latch receiver to control a position of the body of the latch receiver. Each second spring assembly includes a second spring housing including a second pocket, a second spring disposed within the second pocket, and a second pin disposed within the second pocket and extending from the second pocket. The second pins engage a surface of a body of a latch pin to control a position of the body of the latch pin.

### FIELD OF THE DISCLOSURE

Examples of the present disclosure generally relate to latch alignment systems and methods for controlling positions of latch systems.

### BACKGROUND OF THE DISCLOSURE

Latch systems may be used to hold components in a closed position, such as cowl structures of a nacelle of an aircraft. In certain embodiments, the latch systems may include a rod or pin that is shaped and sized to be received within a passage of a cylindrical structure. The cylindrical structure may include a flanged opening to allow clearance of the rod or pin during a coupling event. For example, the flanged opening can accommodate some misalignment of the rod or pin with the passage of the cylindrical structure.

However, in a hinged configuration of the cowl structures, the weight of the latch systems may cause unwanted rotational movement of the components of the latch system. Gravitational or other forces may cause the latch rod or pin and/or the cylindrical structure to droop or hang while the latch rod or pin is disengaged from the cylindrical structure. For example, while the latch components are disengaged, the latch components may be misaligned beyond what the flanged opening of the cylindrical structure can correct. If the rod or pin, or the cylindrical structure are misaligned beyond what the flanged opening of the cylindrical structure can accommodate and/or correct, then a closing event of the cowl structures may cause structural damage to the latch system, the cowling structures, aircraft components disposed within the nacelle, etc.

### SUMMARY OF THE DISCLOSURE

A need exists for a system and a method for an alignment system for a latch system that controls positions of components of the latch system. Further, a need exists for an alignment system for a latch system that can control the alignment of the components of the latch system.

With those needs in mind, certain examples of the present disclosure provide an alignment system for a latch system, such as for a hinged cowl structure of a nacelle of an aircraft or other powered system. The alignment system can include one or more first spring assemblies and one or more second spring assemblies. Each of the first spring assemblies can include a first spring housing that is coupled with a first structure, such as a first cowl structure of a nacelle. The first spring housing includes a first pocket, with a first spring and a first pin disposed within the first pocket. One end of the first pin extends out of the first pocket and away from the first spring housing to engage a surface of a body of a latch receiver. For example, the first pin controls a position of the body of the latch receiver. Each of the second spring assemblies can include a second spring housing that is coupled with a second structure, such as a second cowl structure of the nacelle. The second spring housing includes a second pocket with a second spring and a second pin disposed within the second pocket. One end of the second pin extends out of the second pocket and away from the second spring housing to engage a surface of a body of a latch pin. For example, the second pin controls a position of the body of the latch pin.

In at least one example, the first spring assemblies and the second spring assemblies can control the position of the latch receiver and the latch pin, respectively, while the latch pin is disengaged from the latch receiver. In another example, the first pin may be disengaged from the surface of the body of the latch receiver, and/or the second pin may be disengaged from the surface of the body of the latch pin while the latch pin is coupled with the latch receiver. In at least one example, the first pin may control a distance of rotational travel of the body of the latch receiver, and the second pin may control a distance of rotational travel of the body of the latch pin while the latch pin is separated from the latch receiver.

In at least one example, the body of the latch receiver may rotate in a first direction of rotation while the latch pin is disengaged from the latch receiver, and the first pin may exert a force onto the body of the latch receiver in a second direction of rotation that is opposite the first direction of rotation. For example, gravitational forces may cause the body of the latch receiver to droop or sag, and the first pin may exert a force onto the body of the latch receiver to maintain the position of the latch receiver and reduce the amount of droop of the latch receiver. In another example, the body of the latch pin may rotate in a third direction of rotation while the latch pin is disengaged from the latch receiver, and the second pin may exert a force onto the body of the latch pin in a fourth direction of rotation that is opposite the third direction of rotation. For example, gravitational forces may cause the body of the latch pin to droop or sag, and the second pin may exert a force onto the body of the latch pin to maintain the position of the latch pin and reduce the amount of droop of the latch pin.

In at least one example, the first pin can include a passage that extends between a first side surface and a second side surface of the first pin. The passage may receive a first extension component. The first extension component may control a distance of travel of the first pin into and out of the first pocket. In another example, the second pin can include a passage that extends between a first side surface and a second side surface of the second pin. The passage of the second pin may receive a second extension component. The second extension component may control a distance of travel of the second pin into and out of the second pocket.

In at least one example, the latch system may include at least two first spring assemblies. One first spring assembly may be coupled with the first structure such that the first pin of the first spring assembly engages the surface of the body of the latch receiver on a first side of the latch receiver. The other first spring assembly may be coupled with the first structure such that the first pin of the other first spring assembly engages the surface of the body of the latch receiver on a second side of the latch receiver.

In another example, the latch system may include at least two second spring assemblies. One second spring assembly may be coupled with the second structure such that the second pin of the second spring assembly engages the surface of the body of the latch pin on a first side of the latch pin. The other second spring assembly may be coupled with the second structure such that the second pin of the other second spring assembly engages the surface of the body of the latch pin on a second side of the latch pin.

In at least one example, the latch pin may be disengaged from the latch receiver during a maintenance event or a repair event. In another example, the latch pin may be operably coupled with the latch receiver during an operation event of a powered system, such as a typical operational event of an aircraft. In another example, while the latch pin is operably coupled with the latch receiver, the first spring assembly may be disengaged with the latch receiver, and the second spring assembly may be disengaged from the latch pin.

Certain examples of the present disclosure provide a method that includes controlling an amount of travel of a body of a latch receiver via one or more first spring assemblies, and controlling an amount of travel of a body of a latch pin via one or more second spring assemblies. In at least one example, each of the one or more first spring assemblies may include a first spring housing that is coupled with a first structure (e.g., a first cowl structure of a nacelle of an aircraft or other powered system). The first spring housing includes a first pocket that receives a first spring and a first pin. The first pin extends out of the first pocket and is configured to engage a surface of a body of the latch receiver. In another example, each of the one or more second spring assemblies may include a second spring housing that is coupled with a second structure (e.g., a second cowl structure of the nacelle of the aircraft of other powered system). The second spring housing includes a second pocket that receives a second spring and a second pin. The second pin extends out of the second pocket and is configured to engage a surface of a body of the latch pin.

Certain examples of the present disclosure provide a system that includes a first structure that is coupled with a powered system (e.g., a vehicle system, such as an aircraft system; or a non-vehicle system, such as a turbine). A latch receiver includes a body that is coupled with the first structure. One or more first spring assemblies are operably coupled with the first structure. Each of the first spring assemblies includes a first pin that is configured to engage a surface of the body of the latch receiver. The system also includes a second structure that is coupled with the powered system, and a latch pin having a body that is coupled with the second structure. One or more second spring assemblies are operably coupled with the second structure. Each of the second spring assemblies includes a second pin that is configured to engage a surface of the body of the latch pin. The one or more first spring assemblies control a position of the body of the latch receiver, and the one or more second spring assemblies control a position of the body of the latch pin.

### BRIEF DESCRIPTION OF THE DRAWINGS

FIG. 1 illustrates a perspective view of an aircraft, according to an example of the present disclosure.

FIG. 2 illustrates a perspective view of a nacelle of a propulsion system of an aircraft, according to an example of the present disclosure.

FIG. 3A illustrates a cross-sectional front view of a portion of a nacelle in a closed position, according to an example of the present disclosure.

FIG. 3B illustrates a cross-sectional front view of the portion of the nacelle shown in FIG. 3A in an open position, according to an example of the present disclosure.

FIG. 4A illustrates a cross-sectional front view of a portion of a nacelle in a closed position, according to an example of the present disclosure.

FIG. 4B illustrates a cross-sectional front view of the portion of the nacelle shown in FIG. 4A in an open position, according to an example of the present disclosure.

FIG. 5 illustrates a partial bottom perspective view of a latch system of a nacelle, according to an example of the present disclosure.

FIG. 6 illustrates a side view of the alignment system shown in FIG. 5, according to an example of the present disclosure.

FIG. 7 illustrates a bottom view of the alignment system shown in FIG. 5, according to an example of the present disclosure.

FIG. 8 illustrates a cross-sectional side view of a first spring assembly of an alignment system, according to an example of the present disclosure.

FIG. 9 illustrates a cross-sectional side view of a second spring assembly of an alignment system, according to an example of the present disclosure.

FIG. 10 illustrates a partial side view of a latch system of a nacelle in a first open position, according to an example of the present disclosure.

FIG. 11 illustrates a partial side view of a latch system of a nacelle in a second open position, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

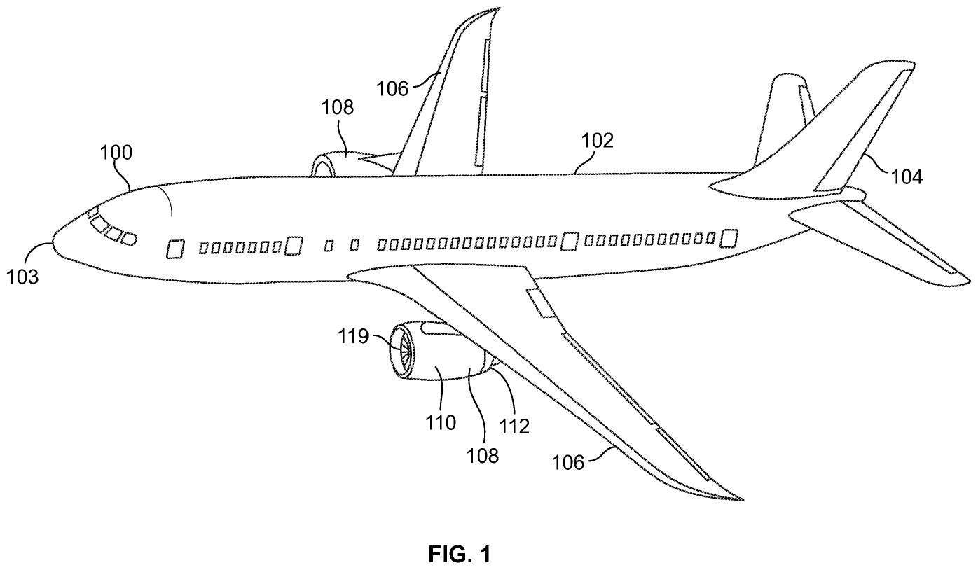

Referring now to the drawings, which illustrate various embodiments of the present disclosure, FIG. 1 is a perspective illustration of an aircraft 100. The aircraft 100 may include a fuselage 102 extending from a nose 103 to an empennage 104. The empennage 104 may include one or more tail surfaces for directional control of the aircraft 100. The aircraft 100 includes a pair of wings 106 extending from the fuselage 102. The aircraft 100 includes one or more propulsion systems 108 which are optionally supported by the wings 106. In an embodiment, each propulsion system 108 may include or represent a gas turbine engine 119 surrounded by a nacelle 110. In an alternative embodiment, one or more of the propulsion systems 108 may include motor-driven rotors surrounded by the nacelle 110 instead of a gas turbine engine. For example, the motor of such propulsion systems 108 may be powered by electrical energy supplied by an onboard battery system and/or an onboard electrical energy generation system. The nacelle 110 may have an exhaust nozzle 112 (e.g., a primary exhaust nozzle and a fan nozzle) at an aft end of the propulsion system 108.

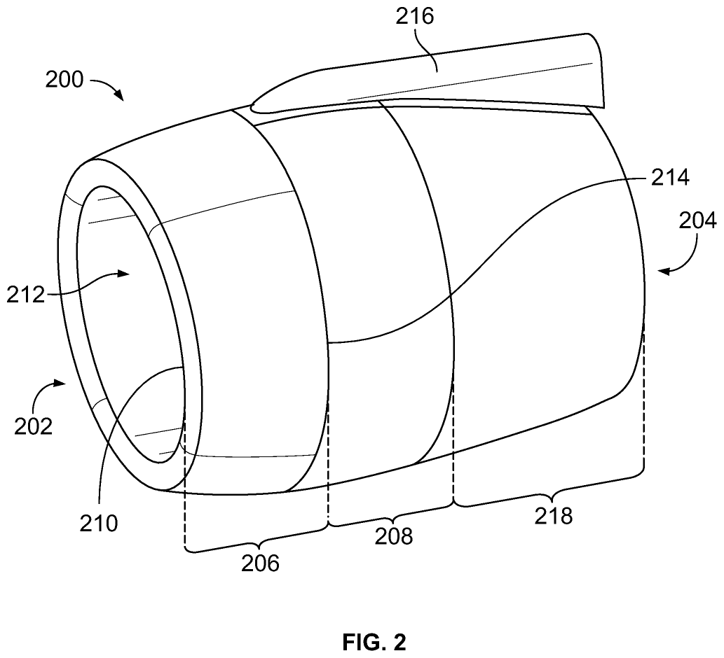

FIG. 2 illustrates an embodiment of a nacelle 200 of a propulsion system of an aircraft according to an embodiment. The nacelle 200 may be one of the nacelles 110 of the propulsion systems 108 shown in FIG. 1. The nacelle 200 extends a length from a front end 202 of the nacelle 200 to an aft end 204 of the nacelle 200 (opposite the front end 202). The nacelle 200 may include an inlet cowl 206 and a fan cowl 208. The inlet cowl 206 defines a leading edge 210 of the nacelle 200 at the front end 202, to direct air into a core 212 of the nacelle 200. The fan cowl 208 is aft of the inlet cowl 206 and is connected to the inlet cowl 206. The fan cowl 208 may connect to and extend from an aft edge 214 of the inlet cowl 206. The fan cowl 208 may surround one or more fans mounted at a forward end of the engine within the core 212.

The nacelle 200 may include a mount 216 for securing the nacelle 200 and the rotary components held by the nacelle 200 to the aircraft. The mount 216 may be a pylon. The nacelle 200 includes at least one aft section 218 that is disposed aft of the fan cowl 208 along the length of the nacelle 200. The aft section(s) 218 may surround engine components such as a compressor, combustion chamber (or combustor), and turbine. The aft section(s) 218 may include or represent a thrust reverser, aft fairing, or the like. The aft section(s) 218 may define the aft end 204 and an aft nozzle through which air and exhaust products are emitted from the propulsion system.

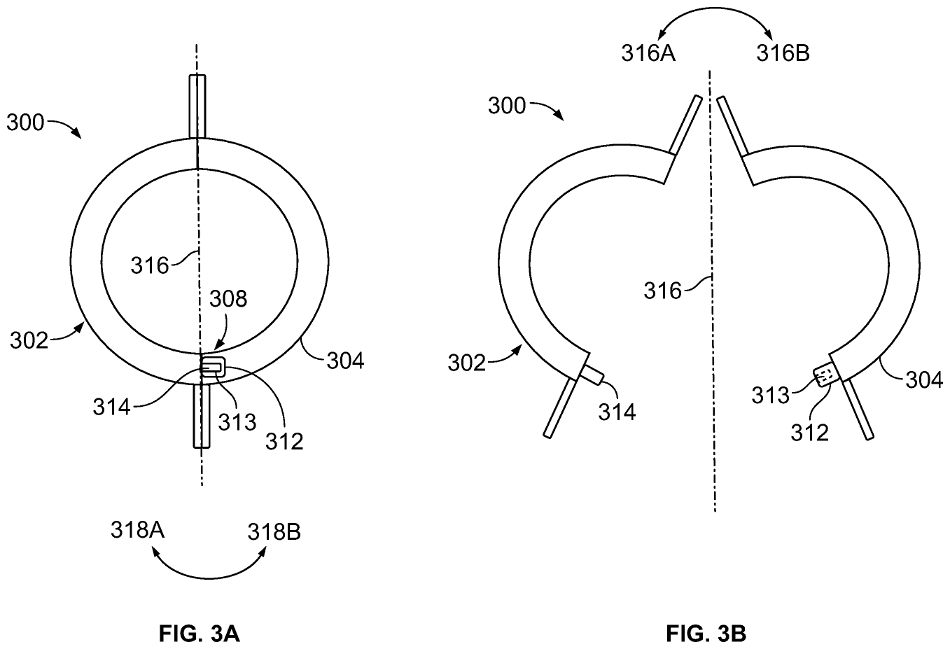

FIG. 3A illustrates a cross-sectional front view of a portion of a nacelle 300 in a closed position according to an example of the present disclosure. FIG. 3B illustrates a cross-sectional front view of the nacelle 300 shown in FIG. 3A in an open position according to an example of the present disclosure. The portion of the nacelle shown in FIGS. 3A and 3B could represent the one of the aft sections 218 illustrated in FIG. 2.

The nacelle 300 includes a first cowl structure 302 that is operably coupled with a second cowl structure 304 in a hinged configuration about a center axis 306. The first cowl structure 302 moves in a direction 318A from the closed position shown in FIG. 3A to the open position shown in FIG. 3B. The first cowl structure 302 moves in a direction 316A from the open position shown in FIG. 3B to the closed position shown in FIG. 3A. The second cowl structure 304 moves in a direction 318B from the closed position shown in FIG. 3A to the open position shown in FIG. 3B; and moves in a direction 316B from the open position shown in FIG. 3B to the closed position shown in FIG. 3A.

The nacelle 300 includes a latch system 308 that couples the first structure 302 with the second structure 304. The latch system 308 includes a latch receiver 312 that is coupled with the second cowl structure 304. The latch receiver 312 includes a latch receiver pocket 313. The latch system 308 also includes a latch pin 314 that is coupled with the first cowl structure 304. In the closed position, as shown in FIG. 3A, the latch pin 314 is disposed and held within the latch receiver pocket 313 of the latch receiver 312. In the open position, as shown in FIG. 3B, the latch pin 314 is separated from the latch receiver pocket 313. In one or more examples, the first and/or second cowl structures 302, 304 may be held or maintained in a closed position by another latch or latching system. For example, in alternative embodiments, the first cowl structure 302 may be held or maintained in a closed position, and the second cowl structure 304 may be moved to an open position.

In one or more examples, one or both of the first or second cowl structures 302, 304 may move from the closed position towards the open position, such as to allow an operator to access an interior portion of the nacelle 300. For example, the cowl structures may surround an engine component that requires maintenance, inspection, repair, replacement, etc.

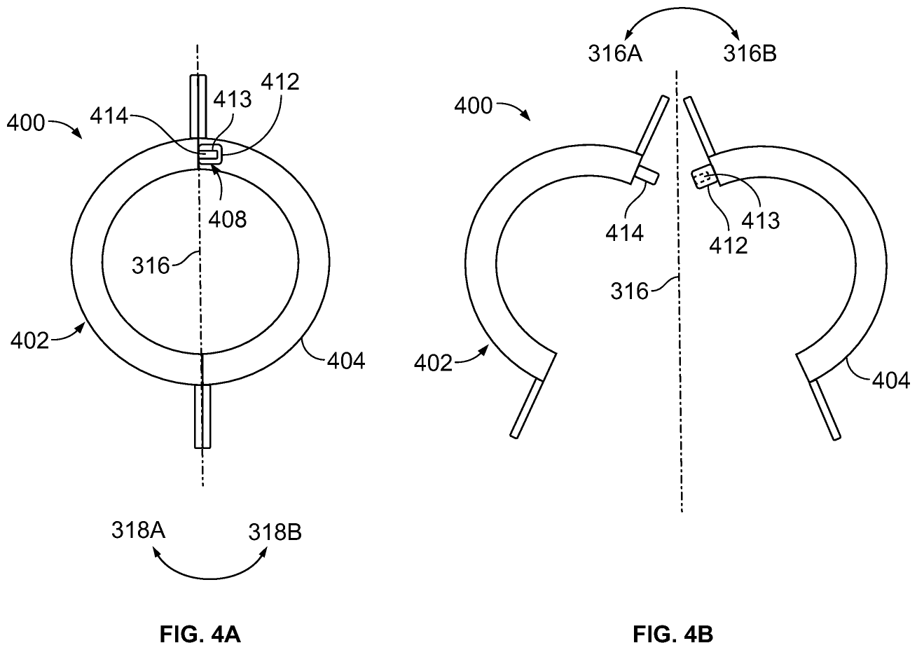

In the illustrated example shown in FIGS. 3A and 3B, the latch system 308 is positioned proximate to a bottom portion of the nacelle 300. In another example, the latch system 308 may be positioned at another portion of the nacelle 300. For example, FIGS. 4A and 4B illustrate a cross-sectional front view of a portion of a nacelle 400, according to another example of the present disclosure. Like the nacelle 300 shown in FIGS. 3A and 3B, the nacelle 400 includes a first cowl structure 402 that is operably coupled with a second cowl structure 404 in a hinged configuration about the center axis 306. The first cowl structure 402 moves in the direction 318A from the closed position shown in FIG. 4A to the open position shown in FIG. 4B; and moves in the direction 316A from the open position shown in FIG. 4B to the closed position shown in FIG. 4A. The second cowl structure 404 moves in the direction 318B from the closed position shown in FIG. 4A to the open position shown in FIG. 4B; and moves in the direction 316B from the open position shown in FIG. 4B to the closed position shown in FIG. 4A.

The nacelle 400 includes a latch system 408 that is positioned proximate to a top portion of the nacelle 400. In the illustrated example, the latch system 408 includes a latch receiver 412 that is coupled with the second cowl structure 404. The latch receiver 412 includes a latch receiver pocket 413. The latch system 408 also includes a latch pin 414 that is coupled with the first cowl structure 402. In the closed position, as shown in FIG. 4A, the latch pin 414 is disposed and held within the latch receiver pocket 413 of the latch receiver 412. In the open position, as shown in FIG. 4B, the latch pin 414 is separated from the latch receiver pocket 413.

In one or more examples, the nacelle may include two latch systems (not shown) with a first latch system positioned proximate a top portion of the nacelle (e.g., as shown in FIGS. 4A and 4B) and a second latch system positioned proximate a bottom portion of the nacelle (e.g., as shown in FIGS. 3A and 3B). In another example, the nacelle may include one or more latch systems that have an alternative arrangement, additional and/or alternative latching components, or any combination therein.

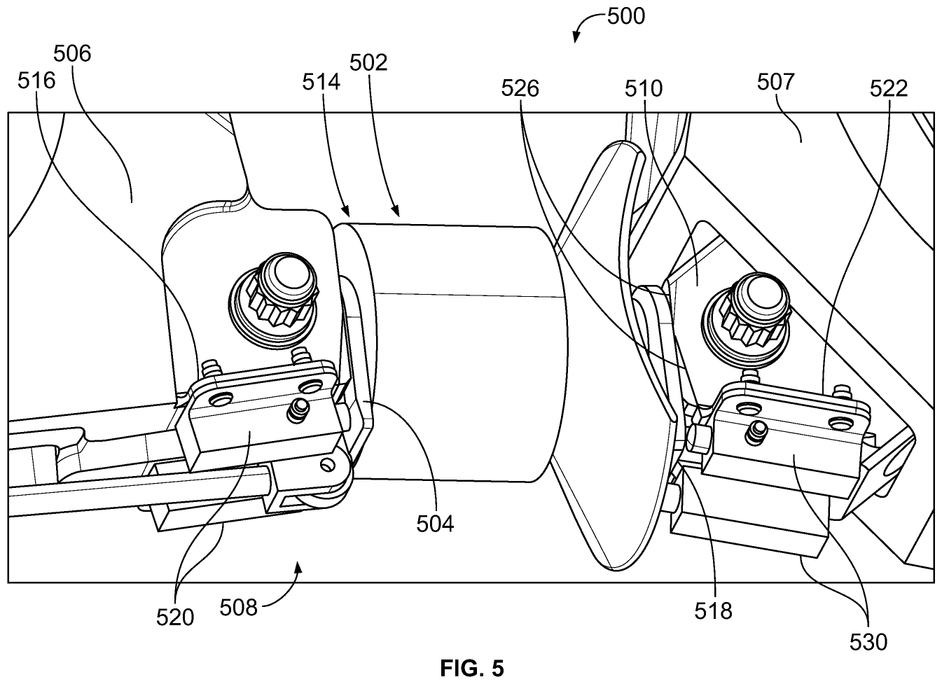

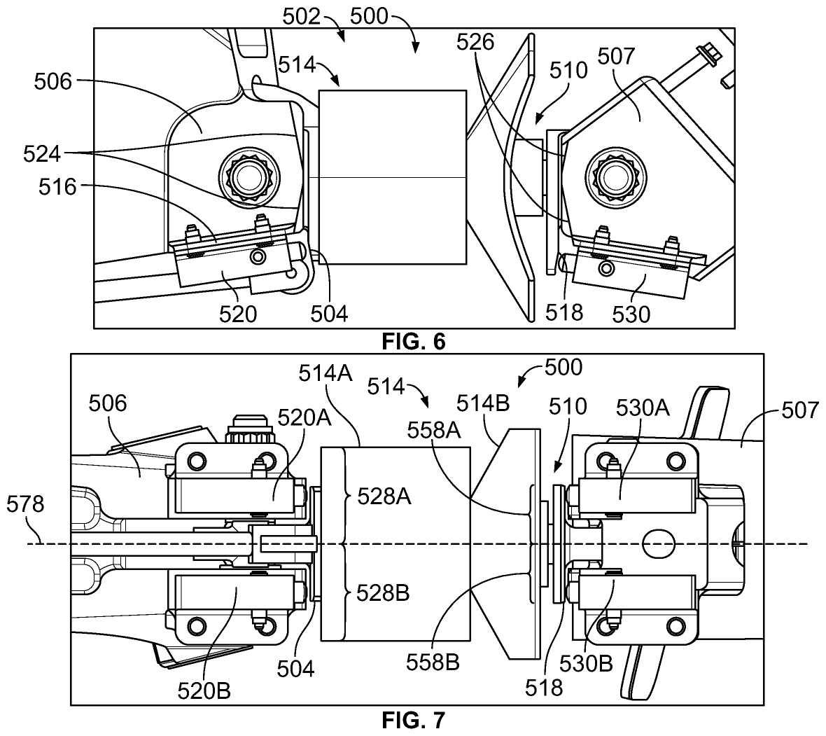

FIG. 5 illustrates a partial bottom perspective view of a latch system 500 of a nacelle, according to an example of the present disclosure. FIG. 6 illustrates a side view of the latch system 500, and FIG. 7 illustrates a bottom view of the latch system 500. FIGS. 5 through 7 will be discussed together herein.

The latch system 500 includes a latch receiver 502 having a body 514 that is coupled with a first structure 506. In one or more examples, the first structure may represent a portion of the first cowl structure 302 of the nacelle 300 shown in FIGS. 3 and 4. The body 514 includes a first portion 514A that is coupled with the first structure 506, and a second portion 514B that is coupled with the first portion 514A. In the illustrated example, the first portion 514A has a substantially circular cross-sectional shape, and is tubular along an axis 578, and the second portion 514B is a flanged structure that is extends away from the axis 578. In the illustrated example, the first structure 506 includes plural chamfers 524 that allow the body 514 of the latch receiver 502 to pivot, rotate, or move relative to an axis that is substantially perpendicular to the axis 578.

The latch system 500 also includes a latch pin 510 that is coupled with a second structure 507, that can represent a portion of the second cowl structure 304 shown in FIGS. 3 and 4. The latch pin 510 includes a body 512 that extends away from the second structure 507. The body 512 of the latch pin 510 is shaped and sized to be received within an opening or passage of the body 514 of the latch receiver 502 that extends along the axis 578. In the illustrated example, the second structure 507 includes plural chamfers 526 that allow the body 512 of the latch pin 510 to pivot, rotate, or move relative to an axis that is substantially perpendicular to the axis 578.

The latch system 500 also includes an alignment system 508. The alignment system 508 controls rotational movement of the body 512 of the latch pin 510 and controls rotational movement of the body 514 of the latch receiver 502. The alignment system 508 includes one or more first spring assemblies 520, and one or more second spring assemblies 530. The first spring assemblies 520 are positioned to control rotational movement of the latch receiver 502, and the second spring assemblies 530 are positioned to control rotational movement of the latch pin 510. In the illustrated example, the latch system 500 includes two first spring assemblies 520A, 520B, and the latch system 500 includes two second spring assemblies 530A, 530B. In one or more examples, the latch system 500 may include a single first spring assembly 520, and/or a single second spring assembly 530. In another example, the latch system 500 may include one or more first spring assemblies 520, but may be devoid the second spring assemblies 530. Or alternatively, the latch system 500 may include one or more second spring assemblies 530, but may be devoid the first spring assemblies 520.

Each of the first spring assemblies 520 is coupled with a flanged surface 516 of the first structure 506. The first spring assemblies 520 are positioned to engage with a surface 504 of the body 514 of the latch receiver 502. One first spring assembly 520A is positioned to engage with the surface 504 on a first side 528A of the body 514 of the latch receiver 502, and the other first spring assembly 520B is positioned to engage with the surface 504 on a second side 528B of the body 514 of the latch receiver 502. The first side 528A of the latch receiver 502 is disposed on one side of the axis 578, and the second side 528B of the latch receiver 502 is disposed on another side of the axis 578.

Each of the second spring assemblies 530 is coupled with a flanged surface 522 of the second structure 507. The second spring assemblies 530 are positioned to engage with a surface 518 of the body 512 of the latch pin 510. One second spring assembly 530A is positioned to engage with the surface 518 on a first side 558A of the body 512 of the latch pin 510, and the other second spring assembly 530B is positioned to engage with the surface 518 on a second side 558B of the body 512 of the latch pin 510. The first side 558A of the latch pin 510 is disposed on one side of the axis 578, and the second side 558B of the latch pin 510 is disposed on another side of the axis 578.

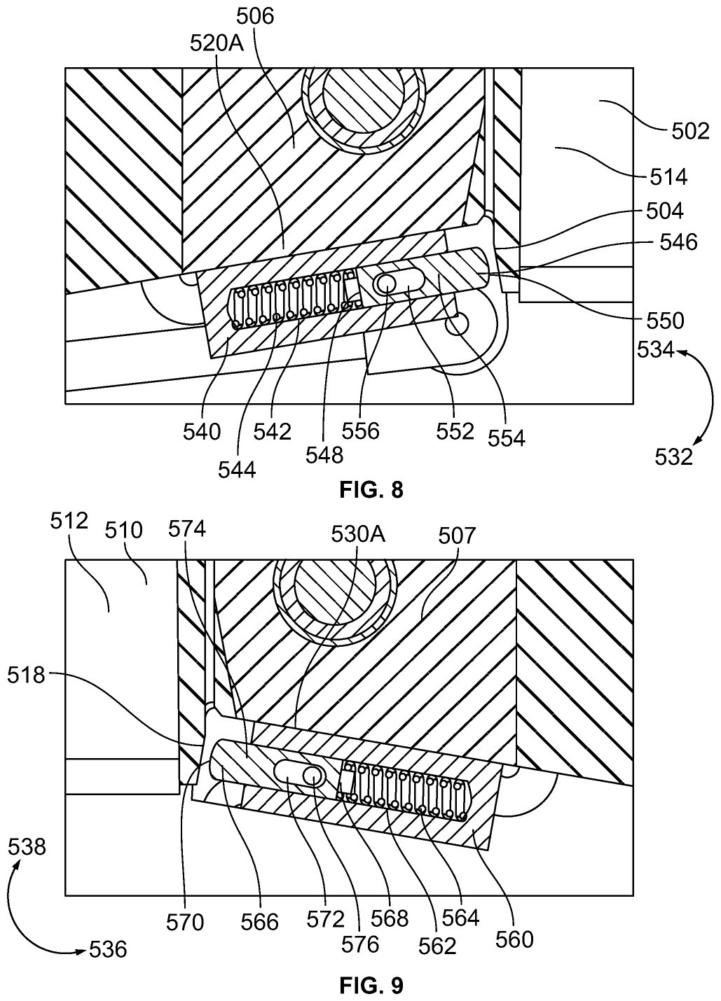

FIG. 8 illustrates a cross-sectional side view of the first spring assembly 520A. The first spring assembly 520B (not shown in FIG. 8) may have a similar arrangement as the first spring assembly 520A. For example, the components and/or arrangements of the components of the first spring assemblies 520A, 520B may be the same or substantially the same.

The first spring assembly 520A includes a first spring housing 540 that is coupled with the flanged surface 516 (shown in FIG. 5) of the first structure 506. The first spring housing 540 includes a first pocket 542 that is an open passage within the first spring housing 540. The first spring assembly 520A also includes a first spring 544 that is disposed within the first pocket 542. In one example, the first spring 544 may be a compression coil spring, but in other embodiments the first spring 544 may be an alternative spring device.

The first spring assembly 520A also includes a first pin 546 that is disposed within the first pocket 542. The first pin 546 extends between a first end 548 that engages with the first spring 544, and a second end 550 that extends out of the first pocket 542 and a distance away from the first spring housing. The second end 550 of the first pin 546 is configured to engage with or make contact with the surface 504 of the body 514 of the latch receiver 502. For example, while the latch pin 510 is separated from the latch receiver 502, the latch receiver 502 may be positioned on the nacelle such that the body 514 of the latch receiver 502 is encouraged (e.g., by gravitational forces) to move in a first direction of rotation 532.

The first pin 546 of the first spring assembly 520A is positioned to engage with the surface 504 of the body 514 of the latch receiver 502 while the latch pin 510 is disengaged or separated from the latch receiver 502. For example, the first pin 546 exerts a force onto the body 514 of the latch receiver 502 that is in a second direction of rotation 534 that is opposite the first direction of rotation 532 of the latch receiver 502. The first pin 546 of the first spring assembly 520A controls a position of the body 514 of the latch receiver 502. For example, the first pin 546 controls or limits a distance of rotational travel of the body 514 of the latch receiver 502 in the first direction of rotation 532. In one or more examples, while the latch pin 510 is engaged with the latch receiver 502, the position of the latch receiver 502 is controlled by the engagement of the latch pin 510 with the latch receiver 502. For example, the second end 550 of the first pin 546 may be disengaged from the surface 504 of the body 514 of the latch receiver 502 while the latch pin 510 is coupled with the latch receiver 502.

In one or more examples, the first pin 546 may include a passage 552 that extends between a first side 554 of the first pin 546 and a second side (not shown in FIG. 8) of the first pin 546 that is opposite the first side 554. In the illustrated embodiment, the passage 552 is a slot that is aligned with the first pocket 542 and aligned with a direction of travel of the first pin 546. The passage 552 may receive a first extension component 556 that may be a stationary structure. In one example, the first extension component 556 may control how far out of the first pocket 542 the first pin 546 is allowed to move. In another example, the first extension component 556 may control a distance of travel of the first pin 546 into and out of the first pocket 542. For example, the distance of travel of the first pin 546 may be controlled based on the size (e.g., length) of the passage 552 of the first pin 546. In one or more examples, the first extension component 556 may be operably coupled with a portion of the first spring housing 540 and/or may be formed as a unitary structure with the first spring housing 540.

FIG. 9 illustrates a cross-sectional side view of the second spring assembly 530A. The second spring assembly 530B (not shown in FIG. 9) may have a similar arrangement as the second spring assembly 530A. For example, the components and/or arrangements of the components of the first spring assemblies 530A, 530B may be the same or substantially the same.

The second spring assembly 530A includes a second spring housing 560 that is coupled with the flanged surface 522 (shown in FIG. 5) of the second structure 507. The second spring housing 560 includes a second pocket 562 that is an open passage within the second spring housing 560. The second spring assembly 530A also includes a second spring 564 that is disposed within the second pocket 562. In one example, the second spring 564 may be a compression coil spring, but in other embodiments the second spring 564 may be an alternative spring device.

The second spring assembly 530A also includes a second pin 566 that is disposed within the second pocket 562. The second pin 566 extends between a third end 568 that engages with the second spring 564, and a fourth end 570 that extends out of the second pocket 562 and a distance away from the second spring housing 560. The fourth end 570 of the second pin 566 is configured to engage with or make contact with the surface 518 of the body 512 of the latch pin 510. For example, while the latch pin 510 is separated from the latch receiver 502, the latch pin 510 may be positioned on the nacelle such that the body 512 of the latch pin 510 is encouraged (e.g., by gravitational forces) to move in a third direction of rotation 536.

The second pin 566 of the second spring assembly 530A is positioned to engage with the surface 518 of the body 512 of the latch pin 510 while the latch pin 510 is disengaged or separated from the latch receiver 502. For example, the second pin 566 exerts a force onto the body 512 of the latch pin 510 that is in a fourth direction of rotation 538 that is opposite the third direction of rotation 536 of the latch pin 510. The second pin 566 of the second spring assembly 530A controls a position of the body 512 of the latch pin 510. For example, the second pin 566 controls or limits a distance of rotational travel of the body 512 of the latch pin 510 in the third direction of rotation 536. In one or more examples, while the latch pin 510 is engaged with the latch receiver 502, the position of the latch pin 510 is controlled by the engagement of the latch pin 510 with the latch receiver 502. For example, the fourth end 570 of the second pin 566 may be disengaged from the surface 518 of the body 512 of the latch pin 510 while the latch pin 510 is coupled with the latch receiver 502.

In one or more examples, the second pin 566 may include a passage 572 that extends between a first side 574 of the second pin 566 and a second side (not shown in FIG. 9) of the second pin 566 that is opposite the first side 574. In the illustrated embodiment, the passage 572 is a slot that is aligned with the second pocket 562 and aligned with a direction of travel of the second pin 566. The passage 572 may receive a second extension component 576 that may be a stationary structure. As one example, the second extension component 576 may control how far out of the second pocket 562 the second pin 566 is allowed to move. In another example, the second extension component 576 may control a distance of travel of the second pin 566 into and out of the second pocket 562. For example, the distance of travel of the second pin 566 may be controlled based on the size (e.g., length) of the passage 572 of the second pin 566. In one or more examples, the second extension component 576 may be operably coupled with a portion of the second spring housing 560 and/or may be formed as a unitary structure with the second spring housing 560.

In one or more examples, the first spring assemblies 520 may be the same, or substantially the same as the second spring assemblies 530. For example, the first and second spring assemblies 520, 530 may include the same or similar components, the components may have a similar arrangement, or any combination therein. For example, the latch system 500 may include four spring assemblies that may be the same, or substantially the same, that may be operably coupled with the latch system 500 at different locations of the latch system 500 to control movement and/or positions of the latch pin 510 and the latch receiver 502.

In an alternative embodiment, the first spring assemblies 520 may have one or more components and/or features that are different than one or more components and/or features of the second spring assemblies 530. For example, the first springs 544 of the first spring assemblies 520 may be different than the second springs 564 of the second spring assemblies 530 such that the forces exerted onto the surface 504 of the latch receiver 502 by the first pins 546 are different than the forces exerted onto the surface 518 of the latch pin by the second pins 566. For example, the body 514 of the latch receiver 502 may be larger (e.g., in size, weight, density, etc.) that the body 512 of the latch pin 510, and the first pins 546 of the first spring assemblies may need to exert a force onto the surface 504 of the latch receiver 502 in the second direction of rotation 534 that is greater than the force the second pins 566 of the second spring assemblies need to exert onto the surface 518 of the latch pin 510 in the fourth direction of rotation 538.

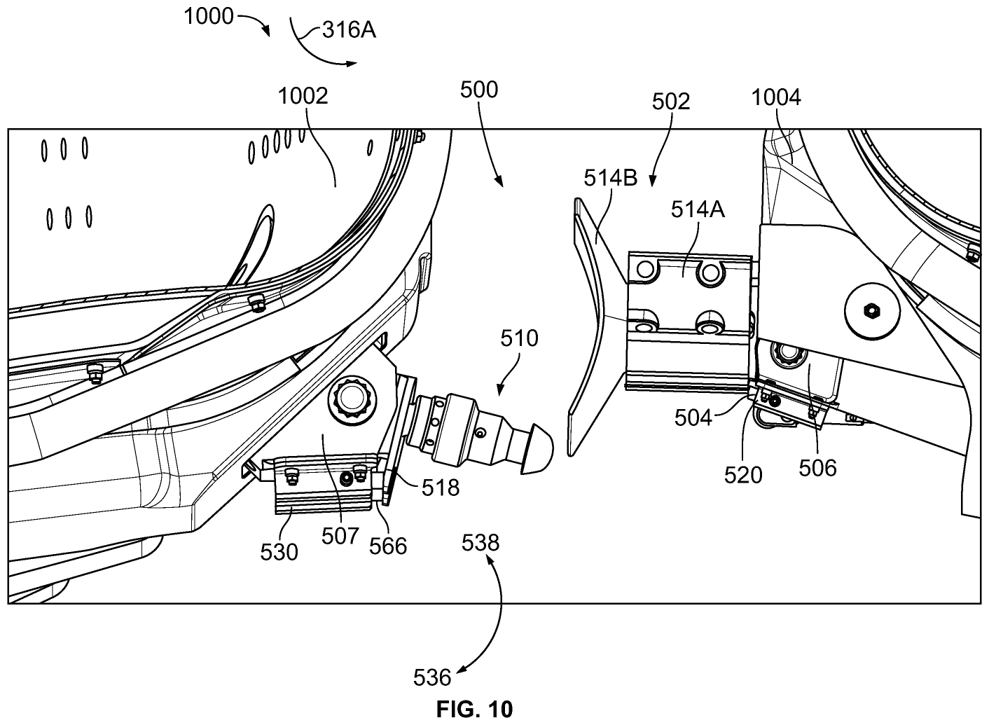

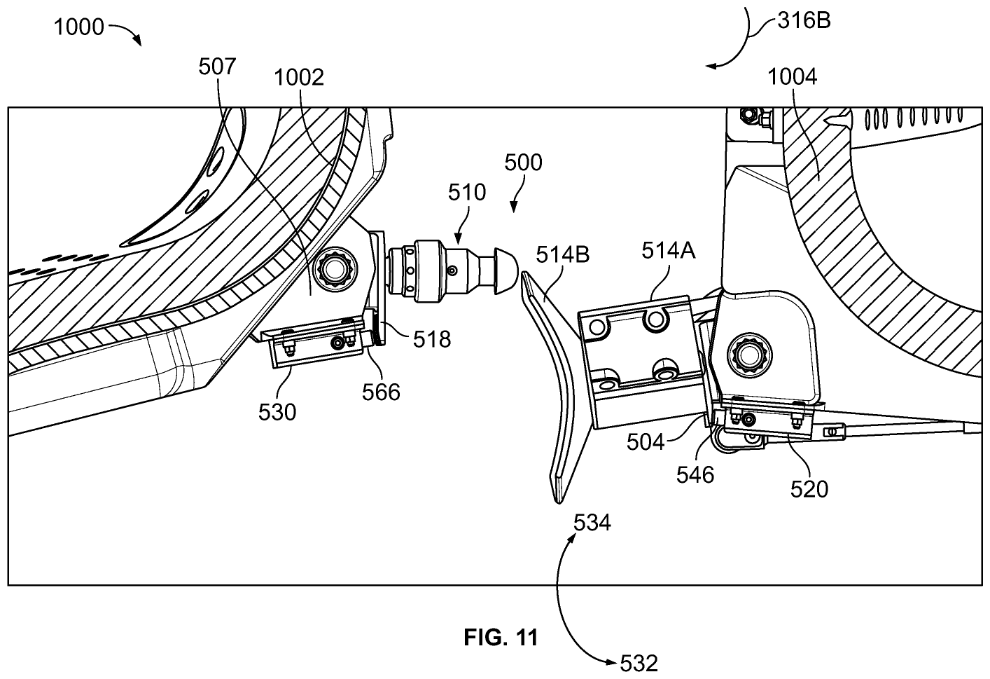

FIG. 10 illustrates a partial side view of the latch system 500 of a nacelle 1000 in a first open position, according to an example of the present disclosure. The nacelle 1000 includes a first cowl structure 1002 and a second cowl structure 1004. In the illustrated embodiment, the latch pin 510 is operably coupled with the first cowl structure 1002 and the latch receiver 502 is operably coupled with the second cowl structure 1004. The latch pin 510 is separated from or disengaged from the latch receiver 502. For example, the latch pin 510 may be separated from the latch receiver 502 in order to move the first and/or second cowl structures away from each other, such as to access engine or other vehicle components disposed within the nacelle 1000 (e.g., during a maintenance and/or inspection event). Alternatively, the latch pin 510 may be coupled with the latch receiver 502 and the first and second cowl structures 1002, 1004 may be in closed positions during operation or an operation event of the aircraft or an alternative powered system.

In the illustrated embodiment of FIG. 10, the first cowl structure 1002 is in an open position and the second cowl structure 1004 is in a closed position. For example, the first cowl structure 1002 will be moved in the direction 316A to move the first cowl structure 1002 to the closed position during a coupling event of the latch pin 510 with the latch receiver 502. While the latch pin 510 is disengaged from the latch receiver 502, gravity encourages the body 512 of the latch pin 510 to move in the third direction of rotation 536. The latch system 500 includes at least two of the second spring assemblies 530. The second pins 566 of each of the second spring assemblies 530 extend away from the corresponding second spring housing and engage with the surface 518 of the body 512 of the latch pin 510. For example, the second pins 566 exert a force on the body 512 of the latch pin 510 in the fourth direction of rotation 538 that is opposite the third direction of rotation 536 to assist with aligning the latch pin 510 with the latch receiver 502.

In the illustrated embodiment, the second spring assemblies 530 control the position of the latch pin 510 so that the latch pin 510 is disposed on an interior side of the second portion 514B (e.g., the flanged structure) of the latch receiver 502 during the coupling event of the latch pin 510 with the latch receiver 502. While the latch pin 510 is disposed on the interior side of the second portion 514B of the latch receiver 502, the latch pin 510 is able to move towards the latch receiver 502 without interfering with a portion of the latch receiver 502 and/or another portion of the second cowl structure 1004 while the first cowl structure 1002 moves in the direction 316A (e.g., towards a closed position of the first cowl structure 1002).

Alternatively, in an embodiment that is devoid the one or more second spring assemblies, the body 512 of the latch pin 510 may hang or droop at a position that may cause the latch pin 510 to move and/or be disposed on an exterior side of the second portion 514B of the latch receiver 502 while the first cowl structure 1002 moves towards the closed position. The latch pin 510 may fail to align with the latch receiver 502 during the coupling event of the latch pin 510 with the latch receiver 502. For example, the latch pin 510 may incorrectly interfere with a portion of the latch receiver 502 while the first cowl structure 1002 moves in the direction 318A (e.g., the closed position of the first cowl structure).

FIG. 11 illustrates a partial side view of the latch system 500 of the nacelle 1000 in a second open position, according to an example of the present disclosure. In the illustrated embodiment of FIG. 11, the first cowl structure 1002 is in a closed position and the second cowl structure 1004 is in an open position. For example, the second cowl structure 1004 will be moved in the direction 316B to move the second cowl structure 1004 to the closed position during a coupling event of the latch pin 510 with the latch receiver 502.

While the latch pin 510 is disengaged from the latch receiver 502, gravity encourages the body 514 of the latch receiver 502 to move in the first direction of rotation 532. The latch system 500 includes at least two of the first spring assemblies 520. The first pins 546 of each of the first spring assemblies 520 extend away from the corresponding first spring housing and engage with the surface 504 of the body 514 of the latch receiver 502. For example, the first pins 546 exert a force on the body 514 of the latch receiver 502 in the second direction of rotation 534 that is opposite the first direction of rotation 532 to assist with aligning the latch pin 510 with the latch receiver 502.

In the illustrated embodiment, the first spring assemblies 520 control the position of the latch receiver 502 so that the latch pin 510 is disposed on the interior side of the second portion 514B (e.g., the flanged structure) of the latch receiver 502 during the coupling event of the latch pin 510 with the latch receiver 502. While the latch pin 510 is disposed on the interior side of the second portion 514B of the latch receiver 502, the latch receiver 502 is able to move towards the latch pin 510 without the interfering with a portion of the latch pin 510 and/or another portion of the first cowl structure 1002 while the second cowl structure 1004 moves in the direction 318B (e.g., towards a closed position of the second cowl structure 1004). For example, the first spring assemblies 520 hold the body 514 of the latch receiver 502 at a position so that the latch pin 510 moves along the interior portion of the second portion 514B of the latch receiver 502 while the latch receiver 502 moves towards the closed position.

Alternatively, in an embodiment that is devoid the one or more first spring assemblies, the body 514 of the latch receiver 502 may hang or droop at a position that may cause the latch pin 510 to move and/or be disposed on an exterior side of the second portion 514B of the latch receiver 502 while the second cowl structure 1004 moves towards the closed position. The latch pin 510 may fail to align with the latch receiver 502 during the coupling event of the latch pin 510 with the latch receiver 502. For example, the latch pin 510 may incorrectly interfere with a portion of the latch receiver 502 while the second cowl structure 1004 moves in the direction 316B (e.g., the closed position of the second cowl structure).

Further, the disclosure comprises examples according to the following clauses:

Clause 1: an alignment system, comprising:
one or more first spring assemblies, each of the one or more first spring assemblies comprising:
a first spring housing configured to be operably coupled with a first structure, the first spring housing including a first pocket;
a first spring configured to be disposed within the first pocket; and
a first pin configured to be disposed within the first pocket, the first pin extending between a first end configured to engage the first spring and a second end configured to extend out of the first pocket and a distance away from the first spring housing, the second end of the first pin configured to engage a surface of a body of a latch receiver to control a position of the body of the latch receiver; and
one or more second spring assemblies, each of the one or more second spring assemblies comprising:
a second spring housing configured to be coupled with a second structure, the second spring housing including a second pocket;
a second spring configured to be disposed within the second pocket; and
a second pin configured to be disposed within the second pocket, the second pin extending between a third end configured to engage the second spring and a fourth end configured to extend out of the second pocket and a distance away from the second spring housing, the fourth end of the second pin configured to engage a surface of a body of a latch pin to control a position of the body of the latch pin.

Clause 2: the alignment system of clause 1, wherein the one or more first spring assemblies are configured to control the position of the body of the latch receiver and the one or more second spring assemblies are configured to control the position of the body of the latch pin while the latch pin is disengaged from the latch receiver.

Clause 3: the alignment system of clauses 1 or 2, wherein the second end of the first pin is configured to disengage from the surface of the body of the latch receiver and the fourth end of the second pin is configured to disengage from the surface of the body of the latch pin while the latch pin is coupled with the latch receiver.

Clause 4: the alignment system of clauses 1-3, wherein the first pin is configured to control a distance of rotational travel of the body of the latch receiver, and the second pin is configured to control a distance of rotational travel of the body of the latch pin.

Clause 5: the alignment system of clause 4, wherein the body of the latch receiver is configured to rotate in a first direction of rotation while the latch pin is disengaged from the latch receiver, wherein the first pin is configured to exert a force onto the body of the latch receiver in a second direction of rotation that is opposite the first direction of rotation of the body of the latch receiver.

Clause 6: the alignment system of clause 4, wherein the body of the latch pin is configured to rotate in a third direction of rotation while the latch pin is disengaged from the latch receiver, wherein the second pin is configured to exert a force onto the body of the latch pin in a fourth direction of rotation that is opposite the third direction of rotation of the body of the latch pin.

Clause 7: the alignment system of clauses 1-6, wherein the first pin includes a passage extending between a first side surface and a second side surface of the first pin, the passage configured to receive a first extension component, the first extension component configured to control a distance of travel of the first pin into and out of the first pocket.

Clause 8: the alignment system of clauses 1-7, wherein the second pin includes a passage extending between a first side surface and a second side surface of the second pin, the passage configured to receive a second extension component, the second extension component configured to control a distance of travel of the second pin into and out of the second pocket.

Clause 9: the alignment system of clauses 1-8, wherein the one or more of the first spring assemblies includes at least two of the one or more first spring assemblies, wherein the second end of the first pin of one of the at least two of the first spring assemblies is configured to engage the surface of the body of the latch receiver on a first side of the latch receiver, and the second end of the first pin of another of the at least two of the first spring assemblies is configured to engage the surface of the body of the latch receiver on a second side of the latch receiver.\

Clause 10: the alignment system of clauses 1-9, wherein the one or more of the second spring assemblies includes at least two of the one or more second spring assemblies, wherein the fourth end of the second pin of one of the at least two of the second spring assemblies is configured to engage the surface of the body of the latch pin on a first side of the latch pin, and the fourth end of the second pin of another of the at least two of the second spring assemblies is configured to engage the surface of the body of the latch pin on a second side of the latch pin.

Clause 11: the alignment system of clauses 1-10, wherein the one or more first spring assemblies are configured to control the position of the body of the latch receiver and the one or more second spring assemblies are configured to control the position of the body of the latch pin during a coupling event of the latch pin and the latch receiver.

Clause 12: a method, comprising:
controlling an amount of travel of a body of a latch receiver via one or more first spring assemblies, each of the one or more first spring assemblies comprising a first spring housing configured to be operably coupled with a first structure, each of the first spring housings including a first pocket configured to receiver a first spring and a first pin, the first pin extending between a first end configured to engage the first spring and a second end configured to extend out of the first pocket, the second end of the first pin configured to engage a surface of the body of the latch receiver; and
controlling an amount of travel of a body of a latch pin operably coupled with a second structure via one or more second spring assemblies, each of the one or more second spring assemblies comprising a second spring housing configured to be operably coupled with the second structure, each of the second spring housings including a second pocket configured to receive a second spring and a second pin, the second pin extending between a third end configured to engage the second spring and a fourth end configured to extend out of the second pocket, the fourth end configured to engage a surface of the body of the latch pin.

Clause 13: the method of clause 12, further comprising controlling the amount of travel of the body of the latch receiver and controlling the amount of travel of the body of the latch pin while the latch pin is disengaged from the latch receiver.

Clause 14: the method of clauses 12-13, further comprising controlling a distance of rotational travel of the body of the latch receiver with the first pin, and controlling a distance of rotational travel of the body of the latch pin with the second pin.

Clause 15: the method of clause 14, wherein the body of the latch receiver is configured to rotate in a first direction while the latch pin is disengaged from the latch receiver, and further comprising exerting a force onto the body of the latch receiver with the first pin in a second direction of rotation that is opposite the first direction of rotation of the body of the latch receiver.

Clause 16: the method of clause 14, wherein the body of the latch pin is configured to rotate in a third direction of rotation while the latch pin is disengaged from the latch receiver, and further comprising exerting a force onto the body of the latch pin with the second pin in a fourth direction of rotation that is opposite the third direction of rotation of the body of the latch pin.

Clause 17: the method of clauses 12-16, further comprising controlling a distance of travel of the first pin into and out of the first pocket with a first extension component, the first extension component disposed within a passage of the first pin.

Clause 18: the method of clauses 12-17, further comprising controlling a distance of travel of the second pin into and out of the second pocket with a second extension component, the second extension component disposed within a passage of the second pin.

Clause 19: the method of clauses 12-18, further comprising controlling the amount of travel of the body of the latch receiver and controlling the amount of travel of the body of the latch pin to align the latch pin with a receiving pocket of the latch receiver during a coupling event of the latch pin and the latch receiver.

Clause 20: a system, comprising:
a first structure operably coupled with a powered system;
a latch receiver comprising a body operably coupled with the first structure;
one or more first spring assemblies operably coupled with the first structure, each of the one or more first spring assemblies comprising a first pin configured to engage a surface of the body of the latch receiver;
a second structure operably coupled with the powered system;
a latch pin comprising a body operably coupled with the second structure; and
one or more second spring assemblies operably coupled with the second structure, each of the one or more second spring assemblies comprising a second pin configured to engage a surface of the body of the latch pin,
wherein the one or more first spring assemblies are configured to control a position of the body of the latch receiver and the one or more second spring assemblies are configured to control a position of the body of the latch pin.

As described herein, examples of the present disclosure provide systems and methods for aligning components of a latch system that are configured to engage and disengage with each other. The alignment systems may maintain or hold a position of a latch pin and/or a latch receiver while the latch pin is disengaged from the latch receiver.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An alignment system, comprising:
one or more first spring assemblies, the one or more first spring assemblies comprising:
a first spring housing configured to be operably coupled with a first structure, the first spring housing including a first pocket;
a first spring configured to be disposed within the first pocket; and
a first pin configured to be disposed within the first pocket, the first pin extending between a first end configured to engage the first spring and a second end configured to extend out of the first pocket and a distance away from the first spring housing, the second end of the first pin configured to engage a surface of a body of a latch receiver to control a position of the body of the latch receiver; and
one or more second spring assemblies, the one or more second spring assemblies comprising:
a second spring housing configured to be coupled with a second structure, the second spring housing including a second pocket;
a second spring configured to be disposed within the second pocket; and
a second pin configured to be disposed within the second pocket, the second pin extending between a third end configured to engage the second spring and a fourth end configured to extend out of the second pocket and a distance away from the second spring housing, the fourth end of the second pin configured to engage a surface of a body of a latch pin to control a position of the body of the latch pin.

2. The alignment system of claim 1, wherein the one or more first spring assemblies are configured to control the position of the body of the latch receiver and the one or more second spring assemblies are configured to control the position of the body of the latch pin while the latch pin is disengaged from the latch receiver.

3. The alignment system of claim 1, wherein the second end of the first pin is configured to disengage from the surface of the body of the latch receiver and the fourth end of the second pin is configured to disengage from the surface of the body of the latch pin while the latch pin is coupled with the latch receiver.

4. The alignment system of claim 1, wherein the first pin is configured to control a distance of rotational travel of the body of the latch receiver, and the second pin is configured to control a distance of rotational travel of the body of the latch pin.

5. The alignment system of claim 4, wherein the body of the latch receiver is configured to rotate in a first direction of rotation while the latch pin is disengaged from the latch receiver, wherein the first pin is configured to exert a force onto the body of the latch receiver in a second direction of rotation that is opposite the first direction of rotation of the body of the latch receiver.

6. The alignment system of claim 4, wherein the body of the latch pin is configured to rotate in a third direction of rotation while the latch pin is disengaged from the latch receiver, wherein the second pin is configured to exert a force onto the body of the latch pin in a fourth direction of rotation that is opposite the third direction of rotation of the body of the latch pin.

7. The alignment system of claim 1, wherein the first pin includes a passage extending between a first side surface and a second side surface of the first pin, the passage configured to receive a first extension component, the first extension component configured to control a distance of travel of the first pin into and out of the first pocket.

8. The alignment system of claim 1, wherein the second pin includes a passage extending between a first side surface and a second side surface of the second pin, the passage configured to receive a second extension component, the second extension component configured to control a distance of travel of the second pin into and out of the second pocket.

9. The alignment system of claim 1, wherein the one or more of the first spring assemblies includes at least two of the one or more first spring assemblies, wherein the second end of the first pin of one of the at least two of the first spring assemblies is configured to engage the surface of the body of the latch receiver on a first side of the latch receiver, and the second end of the first pin of another of the at least two of the first spring assemblies is configured to engage the surface of the body of the latch receiver on a second side of the latch receiver.

10. The alignment system of claim 1, wherein the one or more of the second spring assemblies includes at least two of the one or more second spring assemblies, wherein the fourth end of the second pin of one of the at least two of the second spring assemblies is configured to engage the surface of the body of the latch pin on a first side of the latch pin, and the fourth end of the second pin of another of the at least two of the second spring assemblies is configured to engage the surface of the body of the latch pin on a second side of the latch pin.

11. The alignment system of claim 1, wherein the one or more first spring assemblies are configured to control the position of the body of the latch receiver and the one or more second spring assemblies are configured to control the position of the body of the latch pin during a coupling event of the latch pin and the latch receiver.

12. A method, comprising:
controlling an amount of travel of a body of a latch receiver operably coupled with a first structure via one or more first spring assemblies, the one or more first spring assemblies comprising a first spring housing configured to be operably coupled with the first structure, each of the first spring housings including a first pocket configured to receive a first spring and a first pin, the first pin extending between a first end configured to engage the first spring and a second end configured to extend out of the first pocket, the second end of the first pin configured to engage a surface of the body of the latch receiver; and
controlling an amount of travel of a body of a latch pin operably coupled with a second structure via one or more second spring assemblies, the one or more second spring assemblies comprising a second spring housing configured to be operably coupled with the second structure, each of the second spring housings including a second pocket configured to receive a second spring and a second pin, the second pin extending between a third end configured to engage the second spring and a fourth end configured to extend out of the second pocket, the fourth end configured to engage a surface of the body of the latch pin.

13. The method of claim 12, further comprising controlling the amount of travel of the body of the latch receiver and controlling the amount of travel of the body of the latch pin while the latch pin is disengaged from the latch receiver.

14. The method of claim 12, further comprising controlling a distance of rotational travel of the body of the latch receiver with the first pin, and controlling a distance of rotational travel of the body of the latch pin with the second pin.

15. The method of claim 14, wherein the body of the latch receiver is configured to rotate in a first direction of rotation while the latch pin is disengaged from the latch receiver, and further comprising exerting a force onto the body of the latch receiver with the first pin in a second direction of rotation that is opposite the first direction of rotation of the body of the latch receiver.

16. The method of claim 14, wherein the body of the latch pin is configured to rotate in a third direction of rotation while the latch pin is disengaged from the latch receiver, and further comprising exerting a force onto the body of the latch pin with the second pin in a fourth direction of rotation that is opposite the third direction of rotation of the body of the latch pin.

17. The method of claim 12, further comprising controlling a distance of travel of the first pin into and out of the first pocket with a first extension component, the first extension component disposed within a passage of the first pin.

18. The method of claim 12, further comprising controlling a distance of travel of the second pin into and out of the second pocket with a second extension component, the second extension component disposed within a passage of the second pin.

19. The method of claim 12, further comprising controlling the amount of travel of the body of the latch receiver and controlling the amount of travel of the body of the latch pin to align the latch pin with a receiving pocket of the latch receiver during a coupling event of the latch pin and the latch receiver.

20. A system, comprising:
a first structure configured to be operably coupled with a powered system;
a latch receiver comprising a body configured to be operably coupled with the first structure;
one or more first spring assemblies configured to be operably coupled with the first structure, the one or more first spring assemblies comprising a first pin configured to engage a surface of the body of the latch receiver;
a second structure configured to be operably coupled with the powered system;
a latch pin comprising a body configured to be operably coupled with the second structure; and
one or more second spring assemblies configured to be operably coupled with the second structure, the one or more second spring assemblies comprising a second pin configured to engage a surface of the body of the latch pin,
wherein the one or more first spring assemblies are configured to control a position of the body of the latch receiver and the one or more second spring assemblies are configured to control a position of the body of the latch pin.
